(19) United States
(12) Patent Application Publication
(10) Pub. No.: US 2002/0130880 A1
(43) Pub. Date: Sep. 19, 2002

(54) Locally enhancing display information

(75) Inventors: Antonius Hendricus Maria Holtslag, Eindhoven (NL); Dominicus Johannes Ijntema, Palo Alto, CA (US)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 10/056,362

(22) Filed: Jan. 25, 2002

(30) Foreign Application Priority Data
Mar. 16, 2001 (EP) 01200985.8

(51) Int. Cl. G09G 5/00

(52) U.S. Cl. 345/581

(57) ABSTRACT

A system comprises a display information-generating device, for example a computer, and a display apparatus, for example a monitor, for displaying the display information generated by the display information-generating device on a display screen. The system further comprises a detector for detecting whether a part of the display information corresponding to an area on the display screen has to be enhanced. The part of the display information may be, for example, a Windows window. The detector detects whether in the part of the display information:

(i) an application is one of a group of applications indicating that non-synthetic information is displayed, in which the application is not a picture viewer, or

(ii) an extension of a file is one of a group of extensions indicating that non-synthetic information is displayed, or

(iii) moving information is displayed.

If at least one of these criteria is true, the display information in the area will be enhanced.

The invention relates to a system for enhancing a part of the display information corresponding to an area of a display screen of a display apparatus, to a method of locally enhancing display information, to a computer with provisions for locally enhancing display information, and to a display apparatus with provisions for locally enhancing display information.

WO-A-99/20042 discloses an image display device in which the drive signal range of a cathode ray tube is locally enhanced in a window. The average luminosity in the window is monitored and the drive signal range is reduced if there is a danger of doming in the window. The windows in which the amplification gain is increased can be selected. In one version, this is done by the image source which is, for example, a WEB browser which shows a WEB page containing text and subwindows with photos or video. The WEB browser may indicate one or more of the subwindows with photos or video in order to increase the amplification gain. Alternatively, this is possible by determining the high spatial frequency energy-content in a window, which would be lost by increasing the gain due to increased spot size in the CRT, and comparing it with the low spatial frequency energy-content.

It is an object of the invention to provide a system of a display information-generating device and a display apparatus for displaying the display information, which system has a more reliable way of automatically detecting which window should be enhanced for a larger variety of situations.

To this end, a first aspect of the invention provides a system for enhancing a part of the display information corresponding to an area of a display screen of a display apparatus, as defined in claim 1. A second aspect of the invention provides a method of locally enhancing display information as defined in claim 11. A third aspect of the invention provides a computer with provisions for locally enhancing display information as defined in claim 12. A fourth aspect of the invention provides a display apparatus with provisions for locally enhancing display information as defined in claim 13. Advantageous embodiments of the invention are defined in the dependent claims.

The system comprises a display information-generating device, for example a computer, and a display apparatus, for example a monitor, for displaying the display information generated by the display information-generating device on a display screen. The system further comprises a detector for detecting whether a part of the display information corresponding to an area on the display screen has to be enhanced. The part of the display information may be, for example, a Windows® window. The word “Windows” starting with a capital letter refers to the Microsoft operating system Windows®. The word “windows” starting with a small letter refers to an area of display information as displayed on a screen of a display device. This area may have a rectangular or any other shape.

The detector detects whether in the part of the display information:

(i) an application is one of a group of applications indicating that non-synthetic information is displayed, in which the application is not a picture viewer, or

(ii) an extension of a file is one of a group of extensions indicating that non-synthetic information is displayed, or

(iii) moving information is displayed. If at least one of these criteria is true, the display information in the area will be enhanced.

Synthetic information is computer-synthesized information such as, for example, text, graphics, and tables, and non-synthetic information is not computer-synthesized information, for example, photographs and video/film.

With respect to (i), it may be detected whether the application which provides the information in the area is an application for showing photographs or video. The non pre-published application WOO1/41117 (attorneys docket PHN17.784), discloses a system for improving the image quality of selected video windows when the video information in the window is a photograph or moving video. More specifically, it is disclosed which information has to be transported from the computer to the monitor to enable the monitor to determine the exact position of the window on the display screen. It is further disclosed that the microprocessor in the computer may detect which application is running in a window, and if this application is a picture viewer, indicate to the monitor that a picture is displayed. Therefore, a picture viewer has to be disclaimed. Examples of applications which fall within the group of applications indicating that non-synthetic information is displayed, and which are not picture viewers, are movie players or other applications for showing video, for example from a TV tuner card or from a video recorder, camcorder, or digital (video) camera connected to the PC.

With respect to (ii), it may be detected whether an extension of a file which contains the information to be displayed in the area is one of a group of extensions indicating that non-synthetic information is displayed. Examples of such extensions are: jpg, tiff, mpg, mov and so on.

With respect to (iii), it is detected whether moving information is displayed. Al kinds of known algorithms or circuits may be used to determine whether the information displayed in the area comprises moving objects, such as are present in movies.

Some examples of enhancing of the display information are: an increased light output (a higher brightness or contrast), an increased sharpness, an adapted white color, a noise reduction, or any other signal processing improving the quality of the display information in the area, or drawing the attention to the area.

In an embodiment of the invention as defined in claim 4, the movement in the area is determined by comparing the video data in the area stored at an earlier instant with the corresponding video data at a later instant. If the differences between both video data is larger than a predetermined limit value, it is very likely that movement has occurred. It is, for example, possible to compare the values of each data word of the stored data with the corresponding data word of the later data. If more than a predetermined number of corresponding data words differ more than a predetermined value, it is likely that motion is present. An efficient embodiment of a motion detector is defined in claim 5. Now, the absolute values of the differences of the corresponding data words are summed. If the value of this sum exceeds the limit value, motion is most probably present.

The motion detection can be improved by continuously keeping track of the difference between corresponding data words. Motion is only detected if this difference is almost continuously larger than the limit value. It is not required to compare all the data words in the area, a subset might be sufficient. For example, such a subset might comprise a few lines of data words only, or scattered groups of pixels, or every third pixel.

In an embodiment of the invention as defined in claim 8, the information-generating device provides coordinates defining the area to the display apparatus. The display apparatus comprises the detection circuit. The detection circuit comprises an integrator, a sample-and-hold circuit, and a comparator. At a first instant, the detection circuit determines an intensity value of a line or a sum of lines in the area. The determined intensity value at the first instant is stored by the sample-and-hold circuit. The comparator compares the stored intensity value with a further intensity value of a corresponding line or a sum of lines in the area at a later instant and indicates whether a difference between the stored intensity value and the further intensity value exceeds a limit value. In this way, the detection whether the area contains moving video is performed in the monitor. The monitor receives the coordinates of all areas (windows) to be displayed and decides which areas will be enhanced and which will not be enhanced. The computer does not have to detect which areas have to be enhanced and to send only the coordinates of areas to be enhanced to the monitor, the computer sends the coordinates of all windows to the monitor. This is especially relevant in situations wherein the load of the computer processor should be minimized.

In an embodiment of the invention as defined in claim 9, the video processing automatically enhances the video information in the area when one or more of the criteria (i), (ii), or (iii) is applicable to the video information displayed in the area.

In an embodiment of the invention as defined in claim 10, a user may indicate that an area which is not yet enhanced should be enhanced, or that an automatically enhanced area should not be enhanced. In the latter situation, the user overrules the automatic enhancement function.

These and other aspects of the invention become apparent from and will be elucidated with reference to the embodiments described hereinafter.

In the drawings:

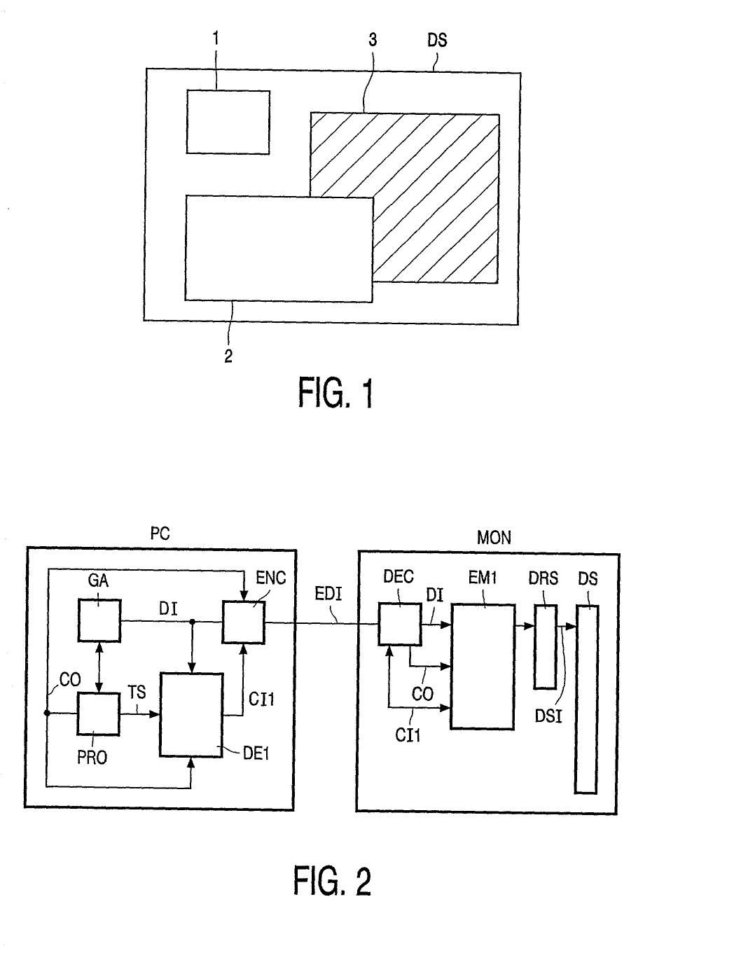

FIG. 1 shows examples of areas on the display screen which correspond to parts of the information,

FIGS. 2 to 5 show a block diagram of an embodiment of the system in accordance with the invention,

FIG. 6 shows a flow chart elucidating an embodiment of the method in accordance with the invention, and

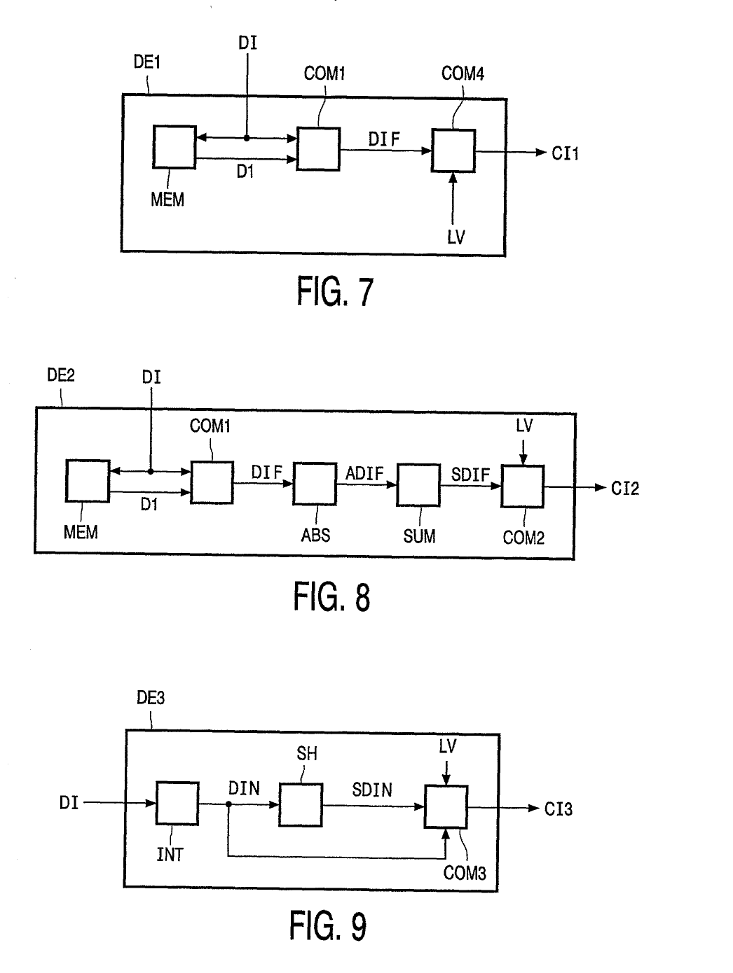

FIGS. 7 to 9 show an embodiment in accordance with the invention of a detection circuit for detecting movement in an area.

FIG. 1 shows examples of areas 1, 2, 3 on the display screen DS, which areas correspond to parts of the display information DI. As an example, only rectangular Windows® windows are shown. The windows might be non-overlapping as shown by window 1, or overlapping as illustrated by window 2 which overlaps window 3. The part 1, 2, 3 of the display information DI to be enhanced corresponds to the area within the rectangle indicating the areas 1 and 2, or may correspond to a non-rectangular area as indicated by the hatched area of window 3. The invention is of course also usable when non-rectangular windows or areas are concerned.

FIGS. 2 to 5 show a block diagram of an embodiment of the system in accordance with the invention.

FIG. 2 shows a system of a computer PC and a monitor MON. The computer PC may be a personal computer, the monitor MON may comprise a cathode ray tube, a liquid crystal display, or any other display device with a display screen DS which displays the display information DI. The PC comprises a graphics adapter GA, which supplies the display information DI to a detection circuit DE1, and an Encoder ENC. The encoder ENC, and the corresponding decoder DEC in the monitor MON are not essential and can be omitted. A processor PRO, for example a microprocessor, controls the graphics adapter GA to supply the display information DI, and controls the detection circuit DE1 to supply a control signal CI1 to indicate whether at least one of the following criteria (i) to (iii) is true in the part 1, 2, 3 of the display information DI:

(i) an application is one of a group of applications indicating that non-synthetic information is displayed, in which the application is not a picture viewer, or

(ii) an extension of a file is one of a group of extensions indicating that nonsynthetic information is displayed, or

(iii) moving information is displayed.

The processor PRO provides coordinates CO of the areas to be enhanced or highlighted to the detection circuit DE1 and to the encoder ENC. The encoder ENC combines the display information, the coordinates CO, and the control information CI1 to obtain an encoded signal EDI which is transported from the computer PC to the monitor MON.

In this embodiment in accordance with the invention, the computer PC detects whether the display information DI in a certain area indicated by the coordinates CO has to be enhanced or not. The computer PC sends the coordinates CO of areas to be enhanced to the monitor MON. The monitor MON comprises the enhancement circuitry. This system has the advantage that the decision whether an area has to be enhanced is taken in the computer PC where the information on the position of the area is available easily, and where the processing power of the available processor can be used to perform the detection algorithm.

The monitor MON comprises the decoder DEC which decodes the encoded display signal EDI into the display information DI, the control signal CI1, and the coordinates CO. An enhancing circuit EMI enhances the areas defined by the coordinates CO when the control signal CI1 indicates to do so. The enhanced video information which is enhanced in the areas is supplied as the drive videosignal DSI to the display screen DS via a drive circuit DRS. The enhancement or highlighting may be an increased light output, an adapted white color, a sharpness improvement, a noise reduction or any other signal-processing algorithm which differs for the area to be enhanced with respect to areas which are not enhanced.

If the computer PC and the monitor MON are separate units interconnected via a standard interface and interface cable, such as the VGA interface and cable, the encoder ENC may combine the display information DI, the control signal CI1 and the coordinates CO such that the encoded information EDI can be transported via the standard interface. Many ways of encoding are known, for example, the control information may be encoded on the video signal during the blanking period, or on the synchronization signal(s) during the scan period, or during the scan period on a limited number of lines of the video information. It is also possible to supply the control signal CI1 and the coordinates CO to the monitor MON via a separate line or via a USB or other bus. If the computer PC and the monitor MON are present in a single unit, the encoder and decoder may be replaced by any other way of providing the information.

A flow chart explaining the operation of an embodiment of the system in accordance with the invention is described with reference to FIG. 6. Embodiments of the detection circuit DE1 which detect motion in the area are described with reference to FIGS. 7 to 9.

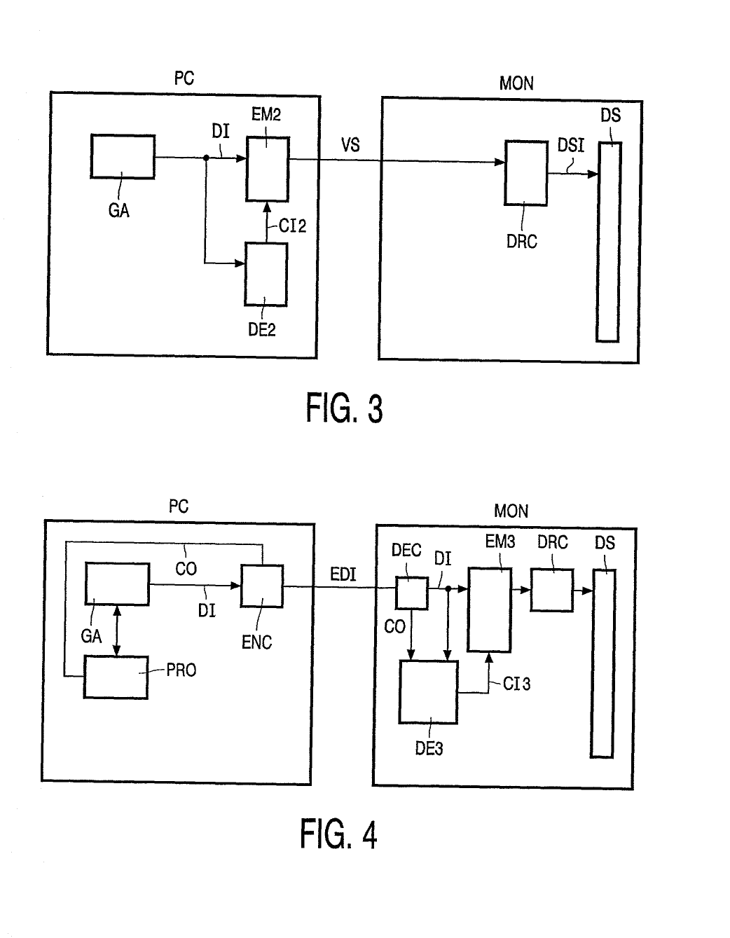

FIG. 3 shows a system of a computer PC and a monitor MON in accordance with another embodiment of the invention. In this embodiment, both the detection and the enhancement are performed in the computer PC. In this way, no control information and no information on the position of the areas has to be supplied to the monitor MON.

The PC comprises a graphics adapter GA, which supplies display information DI to the enhancement circuit EM2 and to the detection circuit DE2. The detection circuit DE2 supplies a control signal CI2 to the enhancement circuit EM2 to indicate whether at least one of the criteria (i) to (iii) is fulfilled in the part (1, 2, 3) of the display information (DI).

The display signal VS supplied to the monitor MON already comprises the enhanced areas.

The monitor MON comprises the drive circuit DRC and the display screen DS and does not require an enhancement circuit and the signals to control it.

FIG. 4 shows a system of a computer PC and a monitor MON in accordance with another embodiment of the invention. In this embodiment, both the detection DE3 and the enhancement EM3 are performed in the monitor MON. The computer PC supplies the coordinates CO of all areas (windows) to the monitor MON. In this way, the extra circuitry in the computer and/or the load on the processor PRO of the computer PC is minimized.

The PC comprises a graphics adapter GA which supplies display information DI to the optional encoder ENC under the control of the processor PRO. The processor PRO further supplies the coordinates CO of all the areas to be displayed to the encoder ENC. The encoded display signal EDI is supplied to the monitor MON. The monitor comprises the decoder DEC and the enhancement circuit EM3. The decoder DEC decodes the display information DI and the coordinates CO from the encoded display information EDI. The detection circuit DE3 receives the display information DI and the coordinates CO to supply a control signal CI3 to the enhancement circuit EM3 to indicate whether at least one of the criteria (i) to (iii) is fulfilled in the part (1, 2, 3) of the display information (DI). The enhancement circuit EM3 will enhance the display information in the area if the control signal CI3 indicates to do so. The display signal with enhanced area(s) is displayed on the display screen DS via a driver circuit DRC.

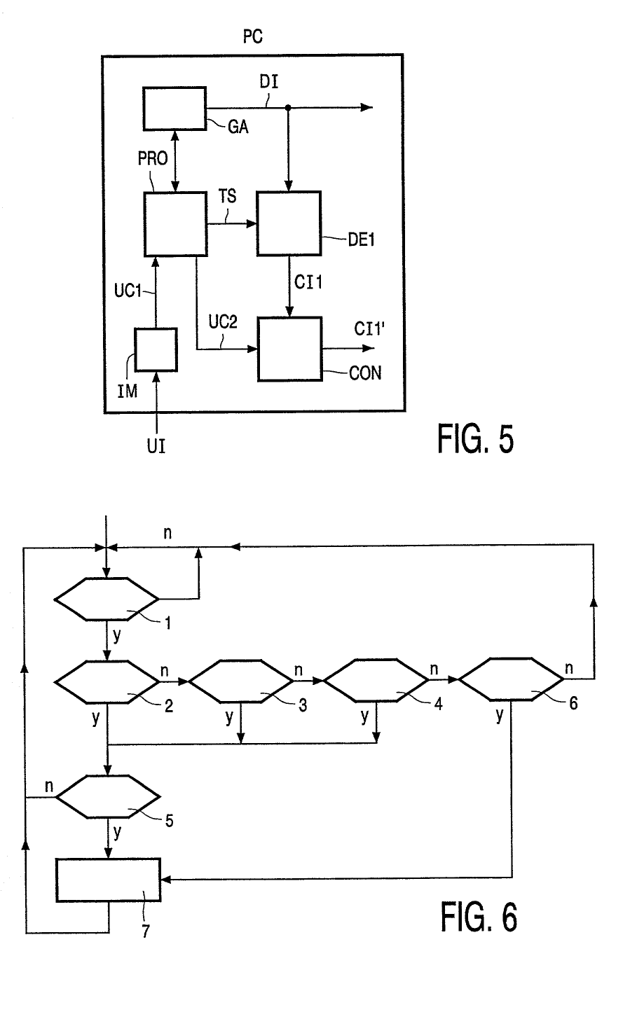

FIG. 5 shows another embodiment of a computer PC. The computer PC further comprises an input circuit IM and a control circuit CON. The part of FIG. 5 which has been described with reference to FIG. 2 is not repeated.

The input circuit IM receives user input UI supplied by a user with an input device (not shown, for example, a mouse or a touch screen) to supply user information UC1 to the processor PRO. The processor PRO supplies the user command UC2 to the control circuit CON to indicate whether the part 1, 2, 3 of the display information DI should be enhanced or not. It is also possible that the input circuit IM supplies the user information UC1 as a command to the control circuit CON directly.

The control circuit CON receives the control signal CI1 from the detection circuit DE1 and the user information UC2 to supply an adapted control signal CI1′ to activate or deactivate the enhancing in correspondence with the user input, independent of the automatic detection by the detection means DE1. In this way, the user is able to overrule the automatic detection by indicating which window which was not detected to be enhanced has to be enhanced, or which window which was detected to be enhanced should not be enhanced.

FIG. 6 shows a flow chart elucidating an embodiment of the method in accordance with the invention. Software (further referred to as HighLight or HL-application) in the computer PC running on the processor PRO selects all possible candidates of areas (further referred to as windows) to be highlighted. In step 1, the HL-application detects whether a window is opened, for example by regularly querying all existing window IDs as available in Windows (Windows with a capital letter refers to the operating system Microsoft Windows®). In step 2, it is detected (for example, from the window ID) which application is associated with the window (for example, mediaplayer.exe), and whether this application is one of the group of applications for which it is very likely that non-synthetic information is displayed in the window. In step 3, it is detected (for example, from the window ID, because the window title of the application displays the opened file, for example my movie.mpeg) which file extension the file opened in the window has (for example, mpeg), and whether this extension is one of a group of extensions for which it is very likely that non-synthetic information is displayed in the window. In step 4, it is detected whether the information displayed in a window is moving. In the embodiment in accordance with the invention as shown in Fig.6, the type of application is checked first, and if the application belongs to the group, step 5 will be performed. If the application in the opened window is not one of the group, it is checked whether the file extension of the file displaying information in the window is one of the group. If so, step 5 is performed. If not, it is checked whether the information displayed in the window is moving. If so, step 5 will be performed, if not, step 6 will be performed. It is possible to alter the order of the steps 2 to 4, or to proceed to step 5 only when two or all of the steps 2 to 4 are answered affirmatively. In the latter situation, there is a greater chance that the window will be highlighted only if the information in the window is non-synthetic. In step 5 it is checked whether user input is received, indicating whether the window opened should be enhanced or not. This user input overrides the automatic determination. If the user information indicates that the window should be enhanced, the window will be enhanced in step 7. If the user information indicates that the window should not be enhanced, the window will not be enhanced and the process will proceed with step 1. If no user information is received with respect to the window, the window will be enhanced in step 7. In step 6 it is detected whether user input is received, indicating whether the window opened should be enhanced or not. This user input overrides the automatic determination. If the user information indicates that the window should be enhanced, the window will be enhanced in step 7. If the user information indicates that the window should not be enhanced, the window will not be enhanced and the process will proceed with step 1. If no user information is received with respect to the window, the window will not be enhanced and the process returns to step 1.

One way of selecting a window for highlighting may be the following. The user sees a window (application) which contains content suitable for highlighting. The user presses a certain predefined “hotkey” on the keyboard (e.g. CRTL-H) and left-clicks with the mouse in the application to be highlighted. The hotkey is necessary to distinguish between regular left-clicks by the mouse and left-clicks intended for the highlight application.

When a user clicks the mouse, the OS (operating system) sends a “Message” (System Call) to the Application (that is the application with the window which has been clicked) to inform the application that the left mouse button has been clicked.

Microsoft Windows has the option to install a so-called system hook, which intercepts the messages sent from the OS to the application. The HiLite application can install a system hook, which will normally pass all these System Calls to the application (e.g., the system acts completely normal), unless the “hotkey” has been pressed. Note: “Hotkeys” are a feature of windows. The HiLite application can define a certain HotKey. Whenever this key combination is pressed, the HiLite application will be informed. When the HotKey is pressed, the “hook” will start analyzing all system calls. Whenever it finds a “left-mouse click system call” it will determine the ID number of the window (in Windows terminology, the window handle, h Wnd) and will pass the Id information to the HiLite application. This specific system call will not be passed to the application (because it was meant to be handled by the “hook”). The HiLite application will determine if the Window ID was from the top level window. If not, the top-level window will be determined (there are Windows API calls for this). Note that an application normally consists of several windows on top of each other. Some are visible, some are not. There is always a child-parent relation between the windows. This will be used to determine the visible top-level window for HiLiting.

The HiLiting application can also detect if other applications are partially hiding the view of the selected window. This can be done by querying all application windows (there is a Windows API call for this) and asking for position, size and z-order (=in front of another window, or behind another window). If another window is partial in front of the HiLited window, the HiLite application may decide not to HiLite, or to “break” the HiLited window into two different blocks (e.g. it is not a square window anymore).

The same technique can be used to track movement of HiLited windows (e.g. when the user moves a certain application, the OS sends system messages to the application (e.g. “move to this position”). When the “hook” sees one of these messages, it will determine the Window ID and send this information to the HiLite application. The HiLite application will determine if this window (or any of its children) are HiLited. If so, the Monitor will receive updated information of the area to be HiLited.

IE and Netscape allow for loading plug-ins which have the option: get detailed knowledge of the browser system. The plug-ins can determine where pictures are positioned on a page (because pictures occur as jpg or gif files in the HTML code). These coordinates can be transferred to the HiLite application. The HiLite application should keep track of the movement of the browser application and the scrolling of the window. (The part to be HiLited is only a part of a window.) An additional problem is that not all pictures are rectangular. Transparent backgrounds are used to make arbitrary shapes. These should not be HiLited.

In Windows, one can get access to the frame buffer (which contains the picture which is displayed on the monitor) by using DirectX API (defined by Microsoft) or by installing a Filter driver between the Graphics Driver and OS/Graphics Display interface. The Filter driver is also able to allow access to the frame buffer.

By scanning the frame buffer (completely, or areas suggested by the HiLite application, because it is discovered that a certain application just started, and it has its window at a certain position), the HiLite application can decide that this is an interesting area to HiLite. The HiLite application could use its information of all Windows to determine the exact area.

A selection criterion could be a certain noisiness or edgi-ness of the content, contouring algorithms (pictures generally do not have rectangular contours, Windows does). In addition to static pictures, movement can be detected.

FIGS. 7 to 9 show an embodiment of a detection circuit for detecting movement in an area in accordance with the invention.

In FIG. 7, the detection circuit DE1 comprises a memory MEM in which the part 1, 2, 3 of the display information DI or a portion of the part of the display information DI is stored as first data D1 at a first instant. A comparator COM 1 compares the first data D1 with second data which is the display information DI of the part or the portion of the part of the display information at a second, later, instant, for example, one frame or 0.1 second later. The comparator COM 1 supplies difference values DIF to a processing circuit COM 4 which supplies the control signal CI1, which indicates whether a difference DIF between the stored display information D1 and the corresponding display information at the second instant exceeds a limit value LV. This difference may be determined data word by data word, and if enough differences occur, it is likely that the display information DI in the area shows a moving image (for example, a movie) and the control signal CI1 is activated. The memory MEM may be the video memory of the graphics or video adapter GA. The comparator COM 1 and the processing circuit COM 4 may be a suitably programmed processor, for example the microprocessor PRO already present in the computer PC. In an alternative embodiment, the detection circuit DE1 may be located in the monitor MON.

In FIG. 8, the detector DE2 comprises a memory MEM in which the part 1, 2, 3 of the display information DI or a portion of the part of the display information DI is stored as first data D1 at a first instant. A comparator COM1 compares the first data D1 with second data which is the display information DI of the part or the portion of the part of the display information at a second, later, instant. The comparator COM1 supplies difference values DIF to a circuit ABS for determining an absolute value ADIF of the difference values DIF. A summer SUM sums the absolute values ADIF of the differences of corresponding data words of the first and the second data to obtain a sum SDIF. A further comparator COM2 compares the sum SDIF with a limit value LV. If the sum SDIF is larger than the limit value, the differences of corresponding data words at different instants are large enough to have a reliable indication that the video information in the window is moving information. This embodiment of the detector DE2 may be implemented in either the computer PC or the monitor MON, and may comprise dedicated hardware or a suitably programmed processor.

In FIG. 9, the detector DE3 comprises an integrator INT which receives the display information DI to supply an intensity value DIN of a line or a sum of lines in the area 1, 2, 3. The integrator INT integrates the display data DI during a time interval corresponding to a part of the area or the complete area to obtain the intensity value DIN. A sample-and-hold circuit SH stores the determined intensity value DIN at a first instant as the stored intensity value SDIN. Or in other words, the intensity value determined during the time interval starting at a first instant is stored. A comparator COM3 compares the stored intensity value SDIN with a further intensity value DIN of a corresponding line or a sum of lines in the area at a later instant to supply the control signal CI3, which indicates whether a difference between the stored intensity value SDIN and the further intensity value DIN exceeds a limit value LV. In this way, the comparator COM3 compares the integrated intensity of corresponding parts of the area at successive periods of time (for example, for successive frames), and determines if this difference is larger than the limit value LV. If the difference exceeds the limit value LV, it is very likely that the display information DI displayed in the area represents moving pictures.

It should be noted that the above-mentioned embodiments illustrate rather than limit the invention, and that those skilled in the art will be able to design many alternative embodiments without departing from the scope of the appended claims.

In the claims, any reference signs placed between parenthesis shall not be construed as limiting the claim. The verb “comprising” does not exclude the presence of elements or steps other than those stated in a claim. The invention can be implemented by means of hardware comprising several distinct elements, and by means of a suitably programmed computer. For example, the detection circuits DE1 and DE2 in FIGS. 2 and 3, respectively, and the enhancement circuit EM2 in FIG. 3 need not be dedicated hardware circuits, but may be implemented as a suitable software algorithm running on the processor PRO of the computer PC. In the device claim enumerating several means, several of these means can be embodied by one and the same item of hardware.

The brightness enhancement can be controlled by the display load as a function of time. The display load is the relative number of cells (pixels) which is on in a picture. The enhancement factor of the extra amount of light in the window to be enhanced may be selected to be the reciprocal value of the display load. The display load may first be filtered to obtain an average value over time. The maximum amount of light in the window may be limited (for example, to 1000 nits).

Instead of Microsoft (R) Windows, other operating systems having a graphical user interface operating with windows can be used, such as OS/2.

1. A system comprising:
a display information-generating device (PC) for generating display information (DI),
a display apparatus (MON) having a display screen (DS) for displaying the display information (DI),
detection means (DE1; DE2; DE3); PRO for detecting whether at least one of the following criteria is fulfilled in a part (1, 2, 3) of the display information (DI) corresponding to an area on the display screen (DS):
(i) an application is one of a group of applications indicating that non-synthetic information is displayed, in which the application is not a picture viewer, or
(ii) an extension of a file is one of a group of extensions indicating that non-synthetic information is displayed, or
(iii) moving information is displayed, and enhancement means (EM1; EM2; EM3) for enhancing the part (1, 2, 3) of the display information if at least one of the criteria (i), (ii), (iii) is true.

2. The system as claimed in claim 1, wherein the display information-generating device comprises a computer (PC), the detection means (DE1; DE2; PRO) being part of the computer (PC) and comprising a suitably programmed microprocessor (PRO) for detecting whether an application is started on the computer (PC), and for determining whether the application started is one of the group of applications, and/or whether the extension of the file associated with the application is one of the group of extensions, and/or whether moving information is displayed.

3. The system as claimed in claim 2, wherein the part (1, 2, 3) of the display information is an active window, and the detection means (DE1; DE2; D3) are suitably programmed to detect whether a window is opened to determine the application associated with the opened window and/or the file extension of the file being displayed in the window from information linked to the window.

4. The system as claimed in claim 1, wherein the detection means (DE1) comprise:
a memory (MEM) for storing the part or a portion of the part (1, 2, 3) of the display information (DI) as first data (D1) at a first instant, and means (COM1, COM4) for comparing the first data (D1) with second data corresponding to the part or a portion of the part of the display information at a second, later, instant, to indicate whether a difference (DIF) between the stored display information (D1) and the corresponding display information at the second instant exceeds a limit value (LV).

5. The system as claimed in claim 1, wherein the detection means (DE2) comprises:
a memory (MEM) for storing the part or a portion of the part (1, 2, 3) of the display information (DI) as first data (D1) at a first instant,
a comparator (COM1) for comparing the first data (D1) with second data corresponding to the part or a portion of the part of the display information at a second, later, instant, to obtain difference values (DIF),
means (ABS) for determining absolute values (ADIF) of the difference values (DIF),
summing means (SUM) for summing the absolute values (ADIF) of the difference values of corresponding data words of the first and the second data to obtain a sum (SDIF), and
a further comparator (COM2) for comparing the sum (SDIF) with a limit value (LV).

6. The system as claimed in claim 4, wherein the memory is the video memory of the video adapter (GA) of a computer (PC).

7. The system as claimed in claim 4, wherein the detection means (DE1); DE2; D3) comprise a suitably programmed microprocessor (PRO).

8. The system as claimed in claim 1, wherein the information-generating device (PC) comprises means (PRO) for supplying coordinates (CO) defining the area (1, 2, 3) to the display apparatus (MON), the display apparatus (MON) comprises the detection means (DE3) which comprise:
an integrator (INT) for determining an intensity value (DIN) of a line or a sum of lines in the area (1, 2, 3),
a sample-and-hold means (SH) for storing the determined intensity value (DIN) at a first instant, and
a comparator (COM3) for comparing the stored intensity value (SDIN) with a further intensity value of a line or a sum of lines in the area at a later instant to supply the control signal (CI3), indicating whether a difference between the stored intensity value (DIN) and the further intensity value exceeds a limit value (LV).

9. The system as claimed in claim 1, wherein the detection means (DE1; DE2; DE3) are adapted to supply the control signal (CI1; CI2; CI3) to automatically activate the enhancing by the enhancement means (EM1; EM2; EM3) if the detection means (DE1; DE2; DE3) detects in the part (1, 2, 3) of the display information (DI) that at least one of the criteria (i), (ii), (iii) is true.

10. The system as claimed in claim 9, wherein the system further comprises input means (IM) for receiving user input (UI) to supply user information (UC1, UC2) indicating whether the part (1, 2, 3) of the display information (DI) should be enhanced or not, and a control means (CON) receiving the control signal (CI1) from the detection means (DE1) and the user information (UC1, UC2) to supply an adapted control signal (CI1′) to activate or deactivate the enhancing in correspondence with the user input, independent of the automatic detection by the detection means (DE1).

11. A method of displaying display information (DI) on a display screen (DS), the method comprising:
detecting (DE1; DE2; DE3) whether at least one of the following criteria is fulfilled in a part (1, 2, 3) of the display information (DI) corresponding to an area on the display screen (DS):
(i) an application is one of a group of applications indicating that non-synthetic information is displayed, in which the application is not a picture viewer, or
(ii) an extension of a file is one of a group of extensions indicating that non-synthetic information is displayed, or
(iii) moving information is displayed, and
enhancing (EM1; EM2; EM3) the part (1, 2, 3) of the display information if at least one of the criteria (i), (ii), (iii) is true.

12. A computer (PC) supplying display information (EDI) for use in a display apparatus (MON) with a display screen (DS), the computer (PC) comprising:
detection means (DE1; DE2; D3) for detecting whether at least one of the following criteria is fulfilled in a part (1, 2, 3) of the display information (DI) corresponding to an area on the display screen (DS):
(i) an application is one of a group of applications indicating that non-synthetic information is displayed, in which the application is not a picture viewer, or
(ii) an extension of a file is one of a group of extensions indicating that non-synthetic information is displayed, or
(iii) moving information is displayed and
means for only providing coordinates (CO) for use in the display apparatus (MON) if at least one of the above criteria (i) to (iii) is true, the coordinates (CO) defining the area.

13. A display apparatus (MON) for displaying display information (DI) on a display screen (DS), the display apparatus comprising detection means (DE3) for deciding whether a part (1, 2, 3) of the display information corresponding to an area on the display screen (DS) has to be enhanced, the detection means (DE3) comprising:
an integrator (INT) for determining an intensity value (DIN) of a line or a sum of lines in the area (1, 2, 3),
sample-and-hold means (SH) for storing the determined intensity value (DIN) at a first instant, and
a comparator (COM3) for comparing the stored intensity value (SDIN) with a further intensity value of a line or a sum of lines in the area at a later instant to supply the control signal (CI3), indicating whether a difference between the stored intensity value (DIN) and the further intensity value exceeds a limit value (LV).

14. A display apparatus as claimed in 13, wherein the display apparatus (MON) comprises means (DEC) for receiving information (CO) defining the position of the area.
